(19) United States
(12) Patent Application Publication
(10) Pub. No.: US 2007/0097991 A1
(43) Pub. Date: May 3, 2007

(54) Method and system for discovering and providing near real-time updates of VPN topologies

(76) Inventor: Lance A. Tatman, Granite Bay, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/263,754

(22) Filed: Oct. 31, 2005

(51) Int. Cl. H04L 12/28

(52) U.S. Cl. 370/395.53

(57) ABSTRACT

Each provider edge router in a provider network connected to one or more VPNs is identified. Each identified provider edge router is then queried to obtain VPN configuration and VPN policy information for each VPN configured on that edge router. Routing protocol messages, such as, for example, Border Gateway Protocol/Multiprotocol Label Switching (BGP/MPLS) and Interior Gateway Protocol (IGP) messages, are then collected from the provider network. Using the discovered policies and topology information, VPN routing information carried in the routing protocol messages can be used to update VPN topology and status information in near real-time.

### BACKGROUND

A Virtual Private Network (VPN) is a network design that provides a logically isolated connection for devices through an unsecured or public network, such as the Internet. Typically the information sent over the VPN is encrypted, resulting in a “virtual network” that is private and allows users to share confidential information over the unsecured network. For example, a company with offices in different cities can create a VPN within the Internet to merge the devices in each office into one private virtual network. The offices can then share corporate and confidential information via the secure VPN.

FIG. 1 is a diagrammatic illustration of a network and a VPN according to the prior art. Provider network 100 includes provider router 102 and provider edge routers 104, 106. Provider edge routers 104, 106 act as an entrance or exit point for a VPN, while provider router 102 does not. Customer sites 108, 110 include customer edge routers 112, 114, respectively, that also act as an entrance or exit point for a VPN. Customer edge router 112 is connected to provider edge router 104 via connection 116 while customer edge router 114 is connected to provider edge router 106 via connection 118. VPN 120 creates a virtual network that links customer site 108 to customer site 110 via provider network 100.

Simple Network Management Protocol (SNMP) messages are used to obtain performance and configuration information for routers 102, 104, 106. Because the service provider operating in provider network 100 does not have SNMP access to customer edge routers 112, 114, provider edge routers 104, 106 must be queried in order to learn whether one or both edge routers 104, 106 connect to one or more VPNs. Affirmative messages generated in response to each query include information about each VPN, and these messages are returned to the device that initiated the query. VPN 120 is discovered when routers 104 and 106 are queried.

The need to query each device increases the burden placed on network devices because each query must be processed by each device and a response formulated and transmitted from each device. Moreover, the amount of time needed to send and receive queries increases as the number of devices in a network increase. For example, a network with a thousand routers results in at least one thousand queries and at least one thousand responses. And since devices are polled periodically, such as every five minutes, any activity that occurs between polling periods may be invisible to the operator. Consequently, topology information cannot be tracked in real time, which results in network management systems containing stale topology information.

### SUMMARY

In accordance with the invention, a method and system for discovering and updating VPN topologies in near real-time are provided. Each provider edge router in a provider network connected to one or more VPNs is identified. Each identified provider edge router is then queried to obtain VPN configuration and VPN policy information for each VPN configured on that edge router. Routing protocol messages, such as, for example, Border Gateway Protocol/Multiprotocol Label Switching (BGP/MPLS) and Interior Gateway Protocol (IGP) messages, are then collected from the provider network. Using the discovered policies and topology information, VPN routing information carried in the routing protocol messages can be used to update VPN topology and status information in near real-time.

### BRIEF DESCRIPTION OF THE DRAWINGS

FIG. 1 is a diagrammatic illustration of a network and a VPN according to the prior art;

FIG. 2 is a diagrammatic illustration of a network and a VPN in a first embodiment in accordance with the invention;

FIG. 3 is a flowchart of a method for discovering VPN topologies in an embodiment in accordance with the invention;

FIG. 4 is a flowchart illustrating a first method for identifying the P and PE routers as shown in block 302 of FIG. 3;

FIG. 5 is a flowchart depicting a method for identifying the BGP routers as shown in block 400 of FIG. 4;

FIG. 6 is a flowchart illustrating a method for identifying the PE routers as shown in block 402 of FIG. 4;

FIG. 7 is a flowchart depicting a second method for identifying the P and PE routers as shown in block 302 of FIG. 3;

FIG. 8 is a flowchart illustrating a third method for identifying the P and PE routers as shown in block 302 of FIG. 3; and

FIG. 9 is a diagrammatic illustration of a network and a VPN in a second embodiment in accordance with the invention.

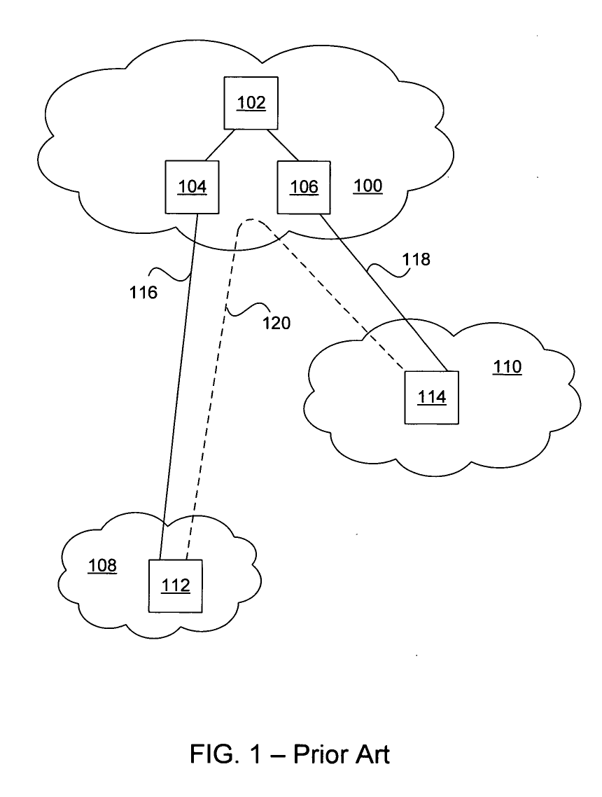

### DETAILED DESCRIPTION

The following description is presented to enable embodiments of the invention to be made and used, and is provided in the context of a patent application and its requirements. Various modifications to the disclosed embodiments in accordance with the invention will be readily apparent, and the generic principles herein may be applied to other embodiments. Thus, the invention is not intended to be limited to the embodiments shown, but is to be accorded the widest scope consistent with the appended claims and with the principles and features described herein.

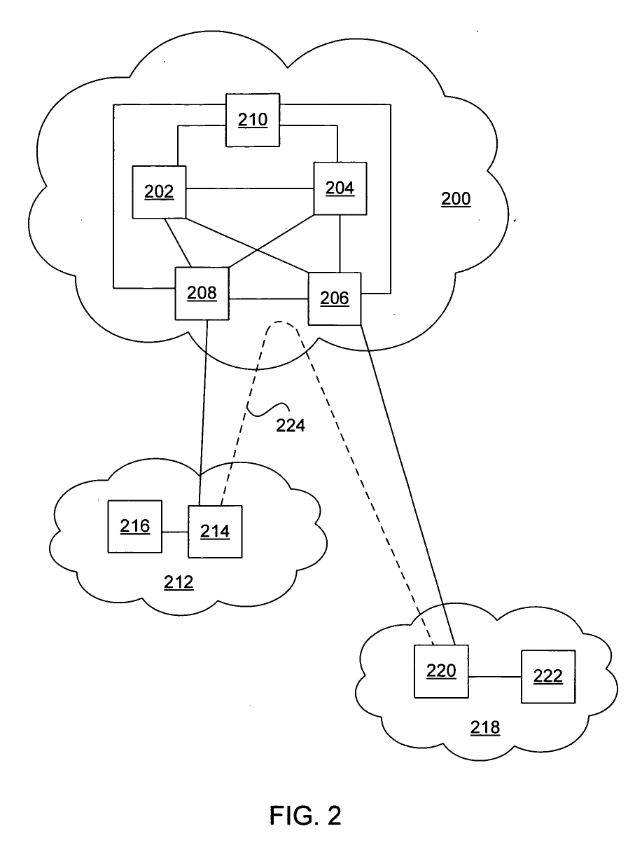

With reference to the figures and in particular with reference to FIG. 2, there is shown a diagrammatic illustration of a network and a VPN in a first embodiment in accordance with the invention. Provider network 200 includes provider (P) routers 202, 204, provider edge (PE) routers 206, 208, and network monitoring unit 210. Customer site 212 includes customer edge (CE) router 214 and customer (C) router 216. Customer site 218 includes customer edge (CE) router 220 and customer (C) router 222. VPN 224 connects customer site 212 to customer site 218 via provider network 200. The topology of provider network 200 is known as a “BGP full mesh” topology in that provider routers 202, 204 and provider edge routers 206, 208 peer with every other BGP-speaking router in network 200.

P routers 202, 204 and PE routers 206, 208 support VPN SNMP MIBS in an embodiment in accordance with the invention. A MIB is a Management Information Base that can be queried to identify which routers are provider routers and provider edge routers along with any VPN configuration and policy. This information is used to begin a topology map and to filter routing announcements based on router policy.

VPN 224 is created using the Border Gateway Protocol/Multiprotocol Label Switching (BGP/MPLS) VPN standard described in RFC 2547bis in an embodiment in accordance with the invention. BGP/MPLS transmits VPN routing information via extensions to the BGP protocol. Multi-protocol BGP is used to exchange external routing information in the embodiment of FIG. 2.

P routers 202, 204 in network 200 are provider owned BGP speaking routers that do not serve as an entrance or exit point for a VPN. PE routers 206, 208 are provider owned BGP speaking routers that serve as either entrance, exit, or both an entrance and an exit for a VPN. Router 214 in customer site 212 and router 220 in customer site 218 are customer owned routers that serve as an entrance, exit, or both an entrance and an exit point to customer sites 212, 218, respectively.

As discussed earlier, routers 202, 204, 206, 208 are BGP peers in network 200. Thus, each router 202, 204, 206, 208 receives routing messages from the other routers. Network monitoring unit 210 discovers and monitors in near real-time the VPN topology of network 200 in an embodiment in accordance with the invention. Network monitoring unit 210 is implemented as a computer or server in an embodiment in accordance with the invention. In other embodiments in accordance with the invention, network monitoring unit is implemented as a purpose-built hardware, such as, for example, an application specific integrated circuit, a field programmable gate array, network processors, or some combination of these devices.

Network monitoring unit 210 maintains a near real-time view of network 200 and the VLANS it supports by establishing peering sessions with routers 202, 204, 206, 208, to receive the advertised routing information. By peering with routers 202, 204, 206, 208, network monitoring unit 210 is provided with the complete VPN information to construct and update a topology database or map using the advertised routing information messages. Because routing updates occur as changes happen, the topology database or map constructed by network monitoring unit 210 provides a near real-time representation of the network state and operational VPN paths.

In other embodiments in accordance with the invention, the VPN topology of network 200 can be determined and monitored using other techniques. One such technique includes peering with a route reflector as described in more detail in conjunction with FIG. 9.

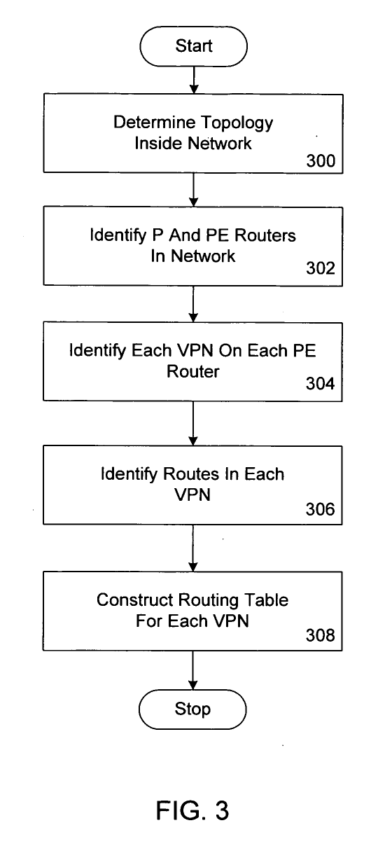

FIG. 3 is a flowchart of a method for discovering VPN topologies in an embodiment in accordance with the invention. Initially the internal topology of a network is discovered, as shown in block 300. One method for discovering the internal topology is to use a network monitoring unit that receives or “listens in” on the internal routing messages being transmitted within the network. Interior Gateway Protocol (IGP) is used to transmit and receive internal routing messages in an embodiment in accordance with the invention. A topology database or map of the interior of the network is then constructed based on these routing messages.

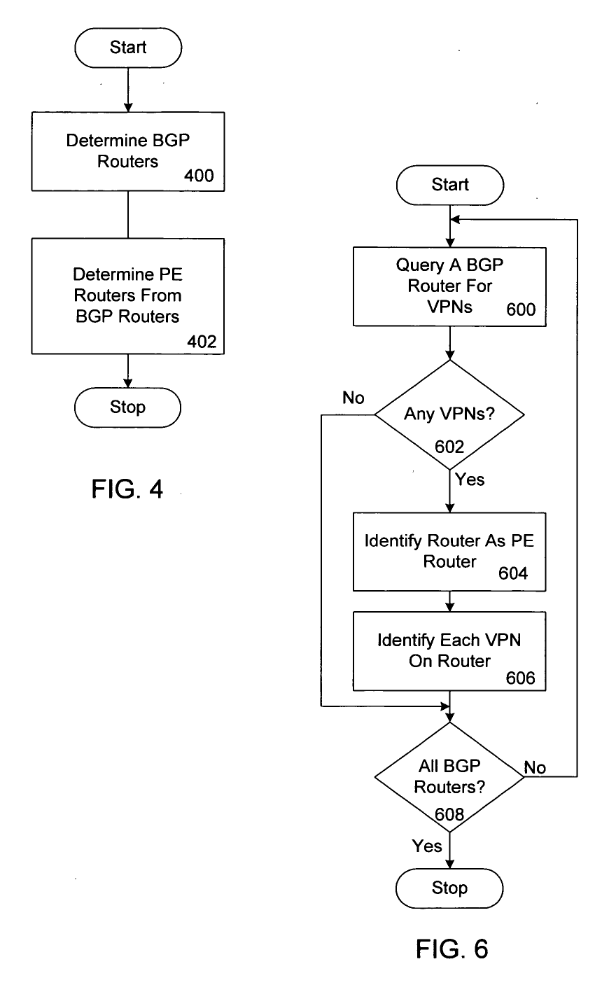

Next, at block 302, the P and PE routers are identified. Techniques for identifying the P and PE routers are described in more detail in conjunction with FIGS. 4, 7, and 8. The PE routers are then queried at block 304 in order to identify each VPN linked to a PE router. The VPNs linked to each PE router are identified using the “mplsVpnVrfFable” in an embodiment in accordance with the invention. The fields accessed from the table include, but are not limited to, the following Management Information Bases (MIBs):

mplsVpnVrfName

mplsVpnVrfDescription

mplsVpnVrfRouteDistinguisher

mplsVpnVrfOperStatus

mplsVpnVrfActivelnterfaces

mplsVpnVrfAssociatedlnterfaces

These MIBs identify which VPNs are carried by which PE routers.

After one or more VPNs are identified, the routes in each VPN and the routing policy for each VPN are identified (block 306). Each route advertised in a VPN includes a route target field identifying the route target value associated with the VPN. The routing policy is obtained by querying each PE router with the “MplsVpnVrfRouteTargetType” SNMP query in an embodiment in accordance with the invention. A routing table, topology map, or topology database is then created for each VPN at block 308 in an embodiment in accordance with the invention.

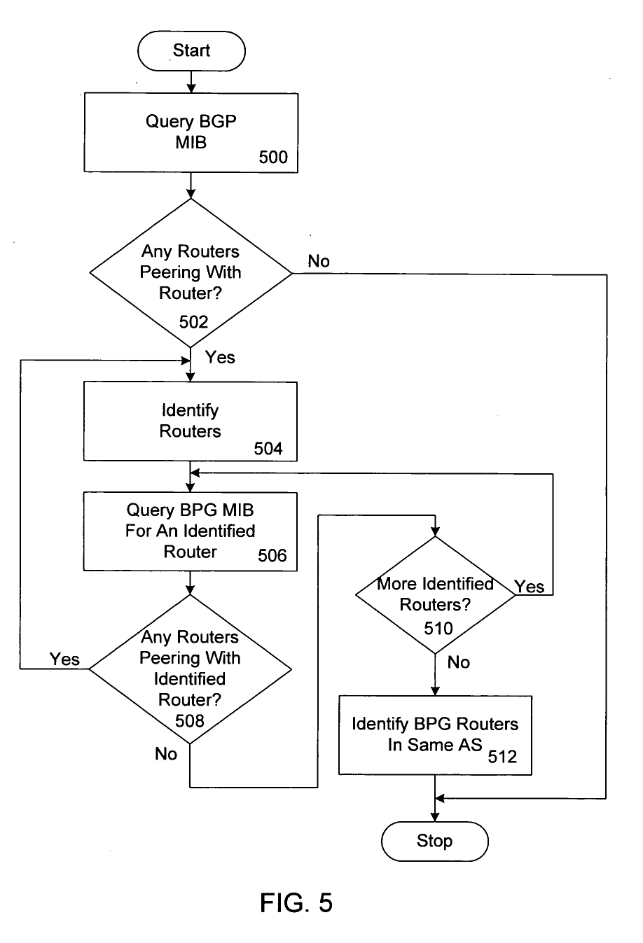

Referring to FIG. 4, there is shown a flowchart illustrating a first method for identifying the P and PE routers as shown in block 302 of FIG. 3. Initially the routers that exchange packets pursuant to BGP are identified, as shown in block 400. This identifies the routers in a network that may be either P or PE routers. One technique for identifying BGP routers is discussed in more detail in conjunction with FIG. 5. Next, at block 402, the PE routers are identified from the BGP routers identified at block 400. FIG. 6 depicts a technique for identifying the PE routers from the BGP routers.

Referring to FIG. 5, there is a flowchart illustrating a method for identifying the BGP routers as shown in block 400 of FIG. 4. In an embodiment in accordance with the invention, a recursive SMNP lookup is performed to identify the BGP routers. Initially the BGP MIB for a known, seed BGP router is queried, as shown in block 500. A determination is then made at block 502 as to whether any routers in the same autonomous system (AS) are peering with the BGP seed router. An AS includes a network or set of networks operating under a single administrative domain (AD). In other embodiments in accordance with the invention, the routers peering with the BGP router in the same AD are determined at block 502.

If there are no routers in the same AS peering with the BGP seed router, the process ends. If there are one or more routers in the same AS peering with the BGP router, the routers are identified at block 504. The BGP MIB for an identified router in the same AS is then queried (block 506) and a determination made as to which routers are peering with the identified router (block 508). If other routers in the same AS are peering with the identified router the process returns to block 504 and repeats until the peering routers are identified.

Once all of the peering routers are identified, a determination is made at block 510 as to whether there is another identified router in the same AS that has not been queried. If so, the method returns to block 506 and repeats until all of the peering routers in the same AS are known. Next, at block 512, the BGP routers in the same AS are determined by comparing the AS numbers for all of the identified BGP routers. Routers with the same AS number are in the same autonomous system, and the P and PE routers are contained in the AS in an embodiment in accordance with the invention.

FIG. 6 is a flowchart illustrating a method for identifying the PE routers as shown in block 402 of FIG. 4. Initially a BGP router is queried using SNMP to obtain information regarding any configured VRFs carried by that router (block 600). A VRF (Virtual Routing and Forwarding (VRF)) table in a VPN allows a PE router to route packets to different VPNs based on the IP address of the packet, even if multiple customers use the same address space. Thus, a PE router with a VRF can contain information regarding one or more VPNs. The SNMP query accesses the P or PE device to obtain information regarding each VPN. The response to this query identifies which routers have at least one configured VPN. The P or PE router is queried using the “mplsVpnConfiguredVrfs” query from PPVPN-MPLS-VPN MIB in an embodiment in accordance with the invention.

A determination is then made at block 602 as to whether there are any configured VPNs carried by the queried router. If there are one or more VPNs, the router is then identified as a PE router (block 604) and each configured VPN carried by the PE router identified (block 606). The VPNs are identified using the mplsVpnVrfTable in an embodiment in accordance with the invention. A determination is then made at block 608 as to whether there are any more BGP routers to be queried. If so, the method returns to block 600 and repeats until there are no more BGP routers to be queried.

The topology information obtained in blocks 602 and 604 includes the name and description of each VPN carried by a PE router and a route distinguisher for each particular VPN. The number of interfaces and the status of the interfaces (i.e., operational or non-operational) for each VPN are also obtained. The route distinguisher is used later when identifying the routes associated with each VPN (see block 306 in FIG. 3). The PE and P routers can now be connected to show possible data paths using the information obtained at block 604 and the internal topology information obtained at block 300 in FIG. 3.

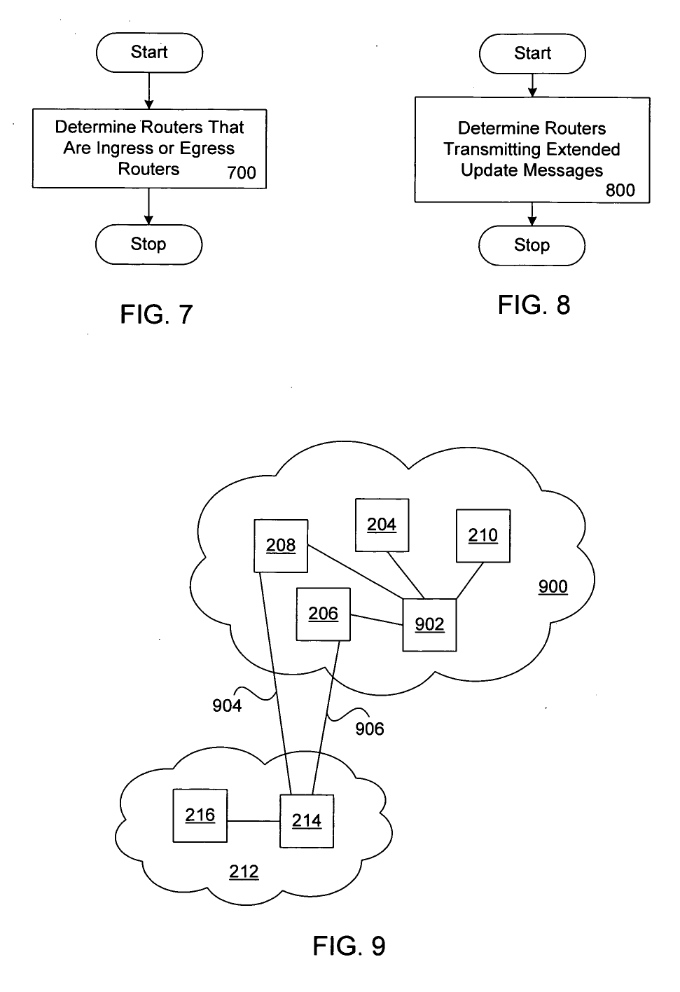

Referring to FIG. 7, there is shown a flowchart depicting a second method for identifying the P and PE routers as shown in block 302 of FIG. 3. The routers that provide an entrance, an exit, or both an entrance and an exit into a VPN are determined, as shown in block 700. The MPLS label-switched path (LSP) discovery is used to determine which routers provide an entrance or an exit to one or more MPLS tunnels in an embodiment in accordance with the invention. Because the routers that provide an entrance or exit to one or more MPLS tunnels may be PE routers and the routers that do not may not be PE routers, the MPLS LSP discovery technique reduces the number of candidate PE routers that must be queried for VLAN configuration information.

FIG. 8 is a flowchart illustrating a third method for identifying the P and PE routers as shown in block 302 of FIG. 3. The routers transmitting extended BGP update messages are determined, as shown in block 800. The extended BGP update messages distribute the routing information in BGP, and can be used to withdraw existing routes, advertise new routes, or both. Unlike a standard BGP update message, an extended BGP update message includes AFI and SAFI fields for both network layer reachability and network layer unreachability data. The AFI and SAFI fields identify the addresses for the VPNs. Only PE routers originate extended BGP update messages with the appropriate AFI & SAFI fields in an embodiment in accordance with the invention.

Referring to FIG. 9, there is shown a diagrammatic illustration of a network and a VPN in a second embodiment in accordance with the invention. Provider network 900 includes route reflector 902, routers 204, 206, 208, and network monitoring unit 210. Customer site 212 includes routers 214, 216. Instead of peering with each other as done in a full mesh topology, routers 204, 206, 208 peer only with route reflector 902. Consequently, the topology information regarding network 900 differs from that of a full mesh network. If network 900 were a full mesh network, routers 204, 206, 208 would advertise their routes to each other and information regarding routes 904, 906 to customer site 212 would be included in all three routers 204, 206, 208. But with route reflector 902, routers 204, 206, 208 advertise their routes only to route reflector 902.

Route reflector 902 selects the best route to customer site 212 and advertises the selected route to routers 204, 206, 208 unless the selected route originated from one of these routers. Consequently, network monitoring unit 210 only has knowledge of one of the available routes to customer site 212 at a time because only the best route selected by the route reflector will be advertised to the network monitoring unit 210. The topology information discovered using the embodiments of FIG. 2 therefore differs from the topology information discovered with the embodiment of FIG. 9.

For example, if route 904 is selected by route reflector 902 as the best route, routers 204, 208 include only route 904 in their routing tables, while router 206 would include both routes 904, 906 in its routing table. Route reflector 902 includes both routes 904, 906 in its routing table but will only advertise route 904. Using the method of FIG. 9 with route reflector 902 provides a topology table or map with information regarding route 904, to VPN 210. The method of FIG. 2 provides a topology table or map with both the selected route (route 904) and route 906 in an embodiment in accordance with the invention.

1. A system for maintaining near real time topology for one or more virtual private networks (VPNs) associated with a provider network, the system comprising:
one or more routers connected to at least one VPN; and
a network monitoring unit operable to determine a topology for each VPN using topology information associated with each VPN, wherein the topology information comprises a routing policy for each router connected to a VPN.

2. The system of claim 1, wherein the one or more routers connected to at least one VPN comprise provider edge routers.

3. The system of claim 2, further comprising one or more provider routers.

4. The system of claim 3, wherein the network monitoring unit is connected to all of the provider and provider edge routers.

5. The system of claim 3, further comprising a route reflector connected to the network monitoring unit, all of the provider edge routers, and all of the provider routers.

6. A system for maintaining near real time topology for one or more virtual private networks (VPNs) in a provider network, the system comprising:
a provider edge router connected to a VPN;
a network monitoring unit operable to determine the topology of the VPN using topology information associated with the VPN, wherein the topology information comprises a routing policy for the provider edge router.

7. The system of claim 6, further comprising a provider router.

8. The system of claim 7, wherein the network monitoring unit is connected to all of the provider routers and provider edge routers.

9. The system of claim 7, further comprising a route reflector connected to the network monitoring unit, the provider edge router, and the provider router.

10. A method for determining a topology for one or more virtual private networks (VPNs), comprising:
identifying each router connected to the one or more VPNs;
obtaining topology information associated with each VPN to determine the one or more routes in each VPN, wherein the topology information comprises a routing policy for each VPN; and
constructing a routing table for each VPN.

11. The method of claim 10, further comprising identifying a router type for each router.

12. The method of claim 11, wherein the router type comprises one of a provider router and a provider edge router.

13. The method of claim 12, wherein identifying each router connected to the one or more VPNs comprises identifying each provider edge router that provides an entrance point or an exit point to the one or more VPNs.

14. The method of claim 13, wherein identifying each provider edge router that provides an entrance point or an exit point to the one or more VPNs comprises identifying each provider edge router that provides an entrance point or an exit point to the one or more VPNs using Multiprotocol Label Switching label-switched path (LSP).

15. The method of claim 12, wherein identifying each router connected to the one or more VPNs comprises determining each router transmitting a Border Gateway Protocol (BGP) extended update message.

16. The method of claim 12, wherein identifying each router in the provider network connected to the one or more VPNs comprises:
determining each router in the provider network that transmits messages using BGP; and
determining each provider edge router from the one or more routers that transmit messages using BGP.

17. The method of claim 16, wherein determining each router in the provider network that transmits messages using BGP comprises performing a recursive Simple Management Network Protocol (SMNP) lookup using a BGP management information base (MIB).

18. The method of claim 16, wherein determining each provider edge router from the one or more routers that transmit messages using BGP comprises querying each BGP router to obtain identifying information associated with each VPN.

19. The method of claim 10, further comprising updating the routing table for each VPN.

20. The method of claim 10, further comprising determining an internal topology for a provider network.
